(19) United States
(12) Patent Application Publication
(10) Pub. No.: US 2019/0215460 A1
(43) Pub. Date: Jul. 11, 2019

(54) User Interface for Control of Building System Components

(71) Applicants: Nancy H. Chen, North Andover, MA (US); Andreas Osten, Berlin (DE); Joseph A. Olsen, Gloucester, MA (US); Rodrigo M. Pereyra, Salem, MA (US)

(72) Inventors: Nancy H. Chen, North Andover, MA (US); Andreas Osten, Berlin (DE); Joseph A. Olsen, Gloucester, MA (US); Rodrigo M. Pereyra, Salem, MA (US)

(73) Assignee: OSRAM SYLVANIA Inc., Wilmington, MA (US)

(21) Appl. No.: 15/866,421

(22) Filed: Jan. 9, 2018

(51) Int. Cl. H04N 5/232; G06F 3/0484; G06F 3/01; G06F 3/0481

(52) U.S. Cl. CPC H04N 5/23293; G06F 3/0481; G06F 3/017; G06F 3/04842

(57) ABSTRACT

Aspects of the present disclosure include simplified user interfaces configured to display one or more symbols for image capture by an image capture device. A computing device with image processing software may be used to process the image to detect the symbol and determine a control function associated with the symbol for controlling one or more building system components. Other aspects include software applications for allowing a user to customize a set of symbols and associated control functions.

### FIELD OF THE DISCLOSURE

The present disclosure generally relates to the field of user interfaces. In particular, the present disclosure is directed to user interfaces for controlling building system components.

### BACKGROUND

Building system components such as lighting systems, components of heating, ventilation and air conditioning (HVAC) systems, and window shades, etc., can be advanced with multiple dimensions of controllability. For example, for HVAC systems, a user may be able to control temperature and humidity. For lighting systems, example control functions can include intensity, whiteness, hue, saturation, spatial distribution, temporal behavior, beam direction, beam angle, beam distribution, and/or beam diameter etc. With increasing control function complexity, there has also been a concomitant increase in the complexity of user interfaces to control building system components. A typical approach can include the use of a graphical user interface (GUI) accessible on a smart phone, tablet or computer that is configured for wireless communication with the building system components. Such user interfaces, though, can increase cost, particularly if convenient and simultaneous control by multiple users is required due to the need for multiple computing devices.

Control of building system components raises particular challenges in sterile environments, such as medical facility operating rooms. In operating rooms, it is desirable to minimize the number of items that must be sterilized. It is also desirable to enable a medical professional performing a procedure, such as a surgeon, to have direct control of one or more building system components, such as surgical overhead lighting.

### SUMMARY OF THE DISCLOSURE

In one implementation, the present disclosure is directed to a method of controlling a building system component. The method includes analyzing, by a processor in a computing device, an image, detecting, by the processor, a symbol in the image, determining, by the processor, a control function associated with the symbol for controlling a building system component, and transmitting a control signal to the building system component to cause the building system component to perform the control function.

In some embodiments, the image is of a space, and the building system component is configured to perform a function in the space. In some embodiments, the symbol is displayed on a user interface located in the space. In some embodiments, the space is an operating room and the building system component is overhead surgical lighting. In some embodiments, the method further includes determining, by the processor, a location of the symbol within the space, in which the control signal includes location information for performing the control function proximate to the location. In some embodiments, the symbol is at least one of a machine-readable pattern printed on a substrate, a machine-readable pattern displayed on a display, or a temporal pattern emitted by a light emitting element. In some embodiments, the method further includes detecting, by the processor, a user gesture over the symbol, and determining, by the processor, the control function associated with the user gesture. In some embodiments, the method further includes determining, by the processor, whether the symbol is associated with a discrete control function or a gradient control function. In some embodiments, the method further includes analyzing, by the processor, a time-subsequent image in response to determining that that the symbol is associated with a gradient control function, determining, by the processor, whether the symbol is in the time-subsequent image, and continuing to transmit the control signal to the building system component in response to determining that the symbol is in the time-subsequent image.

In another implementation, the present disclosure is directed to a system that includes an image capture device configured to capture images of a space, and a processor coupled to the image capture device and configured to analyze an image captured by the image capture device, detect a symbol in the image, determine a control function associated with the symbol for controlling a building system component, and transmit a control signal to the building system component to cause the building system component to perform the control function.

In some embodiments, the image is of a space and the building system component is configured to perform a function in the space. In some embodiments, the symbol is displayed on a user interface located in the space. In some embodiments, the space is an operating room and the building system component is overhead surgical lighting. In some embodiments, the processor is further configured to determine a location of the symbol within the space, in which the control signal includes location information for performing the control function proximate the location. In some embodiments, the symbol is at least one of a machine-readable pattern printed on a substrate, a machine-readable pattern displayed on a display, or a temporal pattern emitted by a light emitting element. In some embodiments, the processor is further configured to detect a user gesture over the symbol, and determine the control function associated with the user gesture. In some embodiments, the processor is further configured to determine whether the symbol is associated with a discrete control function or a gradient control function. In some embodiments, the processor is further configured to analyze a time-subsequent image in response to determining that that the symbol is associated with a gradient control function, determine whether the symbol is in the time-subsequent image, and continue to transmit the control signal to the building system component in response to determining that the symbol is in the time-subsequent image.

### BRIEF DESCRIPTION OF THE DRAWINGS

For the purpose of illustrating the disclosure, the drawings show aspects of one or more embodiments of the disclosure. However, it should be understood that the present disclosure is not limited to the precise arrangements and instrumentalities shown in the drawings, in which:

FIG. 1 is a block diagram of an example control system for controlling one or more building system components with a simplified user interface (UI) that displays one or more symbols for image capture and analysis.

FIG. 2 illustrates a space with building system components controllable by a UI and computing device.

FIG. 3 illustrates another space with building system components controllable by a UI and computing device.

FIG. 4 illustrates an operating room of a medical facility that includes surgical overhead lighting controllable by a UI and computing device.

FIG. 5 shows one example of a gesture-symbol UI.

FIG. 6 illustrates one example method for capturing an image of a symbol displayed on a UI with an image capture device and then processing the image with a computing device to determine a control signal for controlling a function of a building system component.

FIG. 7 illustrates one example sub-process to determine symbol type.

FIG. 8 illustrates one example of a symbol definition user interface 800.

FIG. 9 is a diagrammatic representation of one embodiment of a computing device.

### DETAILED DESCRIPTION

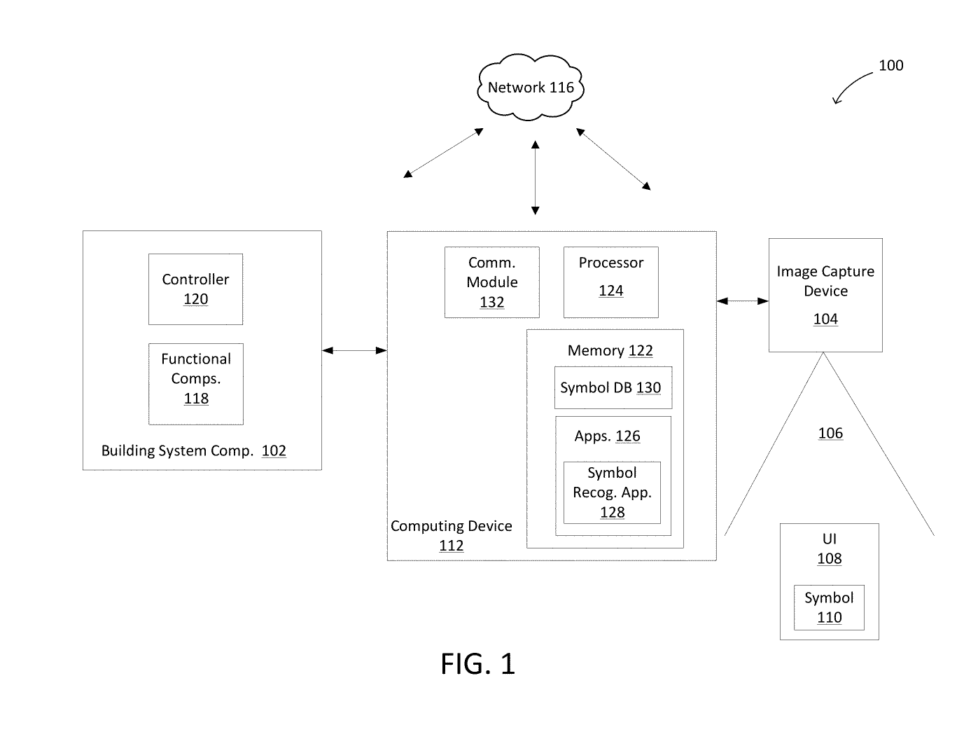

FIG. 1 is a block diagram of an example control system 100 for controlling one or more building system components 102, such as light sources, HVAC systems, window blinds, overhead projectors, music systems, etc. Control system 100 includes an image capture device (ICD) 104 having a field of view (FOV) 106 for capturing images in a space in which building system component 102 performs a function, for example, a space illuminated by a light source of the building system component. A user interface (UI) 108 displays a symbol 110 that can be positioned within image capture device's FOV 106 for transmitting a control signal to building system component 102. System 100 also includes a computing device 112 operably connected to image capture device 104 and building system components 102. Computing device 112 is configured to receive images captured by the image capture device 104 and execute a symbol recognition application 128 to process the images to determine if one or more symbols 110 are present and to determine a corresponding building system component control signal.

System 100 may utilize and recognize a collection of symbols 110, with each symbol corresponding to a desired control function of building system component 102. Symbols 110 can be printed or displayed on any substrate or device. For example, UI 108 may include a placard or other object made available to occupants of a space. A user can make a symbol visible to image capture device 104 to signal a desired change, such as a lighting change. For example, UI 108 may include a book or other collection of pages or other substrates each having one or more symbols 110. In some examples, symbols 110 can be created by printing a symbol on any substrate such as, for example, paper, cardboard, plastic, wood, metal, or any type of textile, such as a napkin, article of clothing or surgical cloth. In another example, UI 108 may include a three dimensional object with one or more symbols printed thereon. For example, flat sheets of material may be folded into forms such as cubes or dodecahedrons for easy handling, or a statue or other figurine with a symbol may be used. In other examples, the shape of a three-dimensional object may constitute a symbol 110. For example, a plurality of three-dimensional objects may be used, with the shape of each three-dimensional object corresponding to a desired control function of building system component 102. In yet other examples, both the shape and orientation of a two or three dimensional object may contain signal information. For example, a particular shape of a two-dimensional object may be associated with a plurality of control functions, each control function associated with a particular orientation of the two dimensional object with respect to some reference point. Similarly, a particular shape of a three-dimensional object may be associated with a plurality of control functions, each control function associated with a particular orientation of the three-dimensional object, for example, whether the three-dimensional object is pointed vertically or horizontally. In other examples, UI 108 may include a display screen of a computing device for display of one or more symbols 110. In one example, a software application may be executed on the UI 108 to display one or more symbols 110. In one example, the UI 108 need not establish a communication link, such as a network connection, with any other component of system 100 and can simply display symbol 110 for capture by image capture device 104. Use of UI 108 may include a user uncovering a symbol 110, flipping to a page in a book which contains a symbol, or orienting a three-dimensional object such that the symbol is oriented upwards toward image capture device 104, selecting a three-dimensional object from a container, etc.

Symbol 110 can incorporate any technique for displaying a computer-vision-recognizable or machine-readable pattern capable of being captured by image capture device 104. For example, symbols 110 may include any shape printed on a substrate with visible or invisible (e.g., fluorescent) ink or objects having unique three-dimensional shapes. In the case of symbols displayed by a display or other light emitting element of an electronic device, symbols 110 can include display of unique patterns in visible or non-visible (e.g., infrared) light, and/or temporal patterns emitted by one or more light emitting elements. Combinations of spatial and temporal symbols 110 may also be used. For example, a blinking pattern may be used to identify a specific user or to differentiate a symbol 110 from other similar-shaped spatial patterns, such as other spatial patterns in the space. Other symbol characteristics that may be varied to communicate information to computing device 112 include symbol color and size.

Building system component 102 can have a wide variety of configurations, depending on the type of component. In the illustrated example, building system component 102 includes one or more functional components 118 for performing a function of the building system component. For example, in the case of a light source, functional components 118 may include one or more solid-state emitters and associated components for causing the light emitters to emit light. A given solid-state emitter may be any semiconductor light source device, such as, for example, a light-emitting diode (LED), an organic light-emitting diode (OLED), a polymer light-emitting diode (PLED), or a combination thereof, among others. A given solid-state emitter may be configured to emit electromagnetic radiation (e.g., light), for example, from the visible spectral band, the infrared (IR) spectral band, the ultraviolet (UV) spectral band, or a combination thereof, among others. In some embodiments, a given solid-state emitter may be configured for emissions of a single correlated color temperature (CCT) (e.g., a white light-emitting semiconductor light source). In some other embodiments, a given solid-state emitter may be configured for color-tunable emissions; for instance, a given solid-state emitter may be a multi-color (e.g., bi-color, tri-color, etc.) semiconductor light source configured for a combination of emissions, such as red-green-blue (RGB), red-green-blue-yellow (RGBY), red-green-blue-white (RGBW), dual-white, or a combination thereof, among others. In some cases, a given solid-state emitter may be configured, for example, as a high-brightness semiconductor light source. In some embodiments, a given solid-state emitter may be provided with a combination of any one or more of the aforementioned example emissions capabilities.

In some examples, control functions of a light source may include on/off, intensity brightness, color, color temperature, and spectral content. Control functions may also include beam direction, beam angle, beam distribution, and/or beam diameter thereby allowing for customizing the spot size, position, and/or distribution of light in a given space or on a given surface of incidence. Example light systems are described in U.S. Pat. No. 9,332,619, titled “Solid-State Luminaire With Modular Light Sources And Electronically Adjustable Light Beam Distribution,” and U.S. Pat. No. 9,801,260, titled, “Techniques And Graphical User Interface For Controlling Solid-State Luminaire With Electronically Adjustable Light Beam Distribution,” each of which is incorporated by reference herein in its entirety.

Controller 120 of building system component 102 may be responsible for translating received inputs (e.g., directly and/or indirectly received from computing device 112) to control one or more functional components 118, such as solid-state lamps of a luminaire, to obtain a given desired light distribution. In some cases, a given controller 120 may be configured to provide for electronic adjustment, for example, of the beam direction, beam angle, beam distribution, and/or beam diameter for a plurality of lamps in a building system component or some sub-set thereof, thereby allowing for customizing the spot size, position, and/or distribution of light in a given space or on a given surface of incidence. In some cases, controller 120 may provide for electronic adjustment, for example, of the brightness (dimming) and/or color of light, thereby allowing for dimming and/or color mixing/tuning, as desired.

Building system component(s) 102 of system 100 may also include, for example, HVAC systems and window blinds, in which case functional components 118 may include, in the case of a window blind, a window covering and associated components for raising and lowering the covering and otherwise adjusting a position of the covering to allow more or less light into a space. In the case of HVAC systems, functional components 118 may include any HVAC system components known in the art, such as components for controlling an air temperature or humidity of a space. Controller 120 may be responsible for translating received inputs (e.g., directly and/or indirectly received from computing device 112) to control one or more functional components 118 such as a position of a window covering or air conditioning, heating and air moving components of a HVAC system.

Image capture device 104 is programmed or otherwise configured to capture or acquire images of an area. For example, when building system component 102 is one or more light sources, FOV 106 of one or more image capture devices 104 can cover substantially all of an illumination area of the light sources such that image capture devices 104 capture images of substantially all of an illumination area illuminated by building system component(s) 102. In some embodiments, FOV 106 can be larger than the illumination area, which may help ensure the captured image has sufficient size to fully include the area of interest. Image capture device 104 can be any device configured to capture digital images, such as a still camera (e.g., a camera configured to capture still photographs) or a video camera (e.g., a camera configured to capture moving images including a plurality of frames), and may be integrated, in part or in whole, with building system component 102 or a separate device that is distinct from the building system component. The images can be permanently (e.g., using non-volatile memory) or temporarily stored (e.g., using volatile memory), depending on a given application, so that they can be analyzed by computing device 112, as further described herein. In an example embodiment, image capture device 104 is a single or high resolution (megapixel) camera that captures and processes real-time video images of an illumination area of building system component 102. Furthermore, image capture device 104 may be configured, for example, to acquire image data in a periodic, continuous, or on-demand manner, or a combination thereof, depending on a given application. In accordance with some embodiments, image capture device 104 can be configured to operate using light, for example, in the visible spectrum, the infrared (IR) spectrum, or the ultraviolet (UV) spectrum, among others. Componentry of image capture device 104 (e.g., optics assembly, image sensor, image/video encoder) may be implemented in hardware, software, firmware, or a combination thereof.

Computing device 112 can include any suitable image processing electronics and is programmed or otherwise configured to process images received from image capture device 104. In particular, computing device 112 is configured to analyze images received from image capture device 104 to identify symbol 110, and to then determine a corresponding control signal for one or more building system components 102 that corresponds to the symbol. Using computer vision algorithms and techniques, computing device 112 can recognize symbol 110. In some examples, system 100 may include a plurality of image capture devices 104. In such instances, the system 100 can be configured to analyze the different views of the image capture devices separately or together (e.g., as a composite image) to determine a change in one or more symbols 110 displayed by UI 108. In some instances, computing device 112 is disposed within a building system component 102 or image capture device 104 while in other instances, the computing device can be positioned at a different location than the building system component (e.g., in another room or building). In such instances computing device 112 may communicate with building system component 102 over wired or wireless network 116, which may be a cloud-based or local server computer.

In accordance with some embodiments, computing device 112 may include a memory 122. Memory 122 can be of any suitable type (e.g., RAM and/or ROM, or other suitable memory) and size, and in some cases may be implemented with volatile memory, non-volatile memory, or a combination thereof. Memory 122 may be utilized, for example, for processor workspace and/or to store media, programs, applications, content, etc., on a temporary or permanent basis. Also, memory 122 can include one or more modules stored therein that can be accessed and executed, for example, by processor(s) 124.

Memory 122 also may include one or more applications 126 stored therein. For example, in some cases, memory 122 may include or otherwise have access to an image/video recording application or other software that permits image capturing/video recording using image capture device 104, as described herein. In some cases, memory 122 may include or otherwise have access to an image/video playback application or other software that permits playback/viewing of images/video captured using image capture device 104. In some embodiments, one or more applications 126 may be included to facilitate presentation and/or operation of graphical user interfaces (GUIs) described herein.

Applications 126 may include a symbol recognition application 128 for recognizing symbols 110 and changes in the symbols in one or more images captured by image capture device 104. For example, in some embodiments, symbol recognition application 128 may include instructions for causing processor 124 to analyze images received from image capture device 104 and identify symbol 110, thereby indicating a control signal should be sent to one or more building system components 102. Any of a variety of known computer vision techniques and techniques developed in the future may be employed. In one example, symbol recognition application 128 may employ standard image processing techniques to identify symbols 110 and changes in the symbols. In one example, symbol recognition application 128 may include image acquisition, pre-processing (e.g., to reduce noise and enhance contrast), feature extraction, segmentation of one or multiple image regions which contain a specific object of interest, and further processing of the processed images to identify symbols 110 and in some cases, symbol orientation, or user gestures proximate a symbol.

In an example embodiment, computing device 112 receives images of a space from image capture device 104. Once received, symbol recognition application 128 can be executed to process the images. In one example, symbol recognition application 128 can incorporate computer vision algorithms and techniques to process the images to detect or otherwise determine whether one or more new symbols 110 have been presented to the image capture device, and/or if a change in one or more of the symbols has occurred. In some examples, symbol recognition application 128 may utilize a training set of images to learn symbols 110. The set of images, in some embodiments, includes previous images of symbols 110. The set of images can be created from the perspective of the image capture device when installed (e.g., looking down into a space from a ceiling). Symbol recognition application 128 can learn various shapes of pixels that correspond to symbols 110, and then analyze the received images to determine if any group of pixels corresponds to a known symbol (e.g., object classification using segmentation and machine learning).

Memory 122 may also include a symbol database 130 which may store information on the characteristics of a plurality of symbols. Symbol database 130 may also include a plurality of control functions for controlling one or more functions of building system component 102. In one example, symbol database 130 may also include one or more defined relationships for associating a symbol with a particular control function. After recognizing a symbol 110 displayed by UI 108, symbol recognition application 128 may be configured to access symbol database 130 to determine one or more control functions associated with the identified symbol.

Computing device 112 may also include a communication module 132, in accordance with some embodiments. Communication module 132 may be configured, for example, to aid in communicatively coupling computing device 112 with: (1) building system component 102 (e.g., the one or more controllers 120 thereof); (2) image capture device 104; and/or (3) network 116, if desired. To that end, communication module 132 can be configured, for example, to execute any suitable wireless communication protocol that allows for data/information to be passed wirelessly. Note that each of computing device 112, building system component 102, and image capture device 104 can be associated with a unique ID (e.g., IP address, MAC address, cell number, or other such identifier) that can be used to assist the communicative coupling there between, in accordance with some embodiments. Some example suitable wireless communication methods that can be implemented by communication module 132 of computing device 112 may include: radio frequency (RF) communications (e.g., Wi-Fi®; Bluetooth®; near field communication or NFC); IEEE 802.11 wireless local area network (WLAN) communications; infrared (IR) communications; cellular data service communications; satellite Internet access communications; custom/proprietary communication protocol; and/or a combination of any one or more thereof. In some embodiments, computing device 112 may be capable of utilizing multiple methods of wireless communication. In some such cases, the multiple wireless communication techniques may be permitted to overlap in function/operation, while in some other cases they may be exclusive of one another. In some cases a wired connection (e.g., USB, Ethernet, FireWire, or other suitable wired interfacing) may also or alternatively be provided between computing device 112 and the other components of system 100.

In some instances, computing device 112 may be configured to be directly communicatively coupled with building system component 102. In some other cases, however, computing device 112 and building system component 102 may optionally be indirectly communicatively coupled with one another, for example, by an intervening or otherwise intermediate network 116 for facilitating the transfer of data between the computing device and building system component. Network 116 may be any suitable communications network, and in some example cases may be a public and/or private network, such as a private local area network (LAN) operatively coupled to a wide area network (WAN) such as the Internet. In some instances, network 116 may include a wireless local area network (WLAN) (e.g., Wi-Fi® wireless data communication technologies). In some instances, network 116 may include Bluetooth® wireless data communication technologies. In some cases, network 116 may include supporting infrastructure and/or functionalities such as a server and a service provider, but such features are not necessary to carry out communication via network 116.

Applications other than or in addition to control of building system component 102 are also contemplated by the present disclosure. For example, UI 108 may be used for transmitting information to computing device for some use. For example, in a classroom, auditorium, lecture hall, restaurant, or any other space, one or more people can display one of UI 108 to transmit information to computing device 112. For example, in a classroom setting, a test, quiz, or other poll can be conducted by a teacher presenting a multiple choice question to the class, and each student can display his or her own UI 108 to select an answer. Image capture device 104 can capture one or more images of the space and symbol recognition application 128 can be configured to identify symbols in the image. Each UI 108 may also include a location or identification symbol for identifying the student, or the computing device could identify the student by associating a location of the symbol in the imaged area with a student's assigned seat. A similar approach may be used in a sport arena to enable audience members to participate in polls, or order items from a concession stand for delivery to the audience member. Guests at a restaurant may use UI 108 to call a waiter or to order items from a menu, etc.

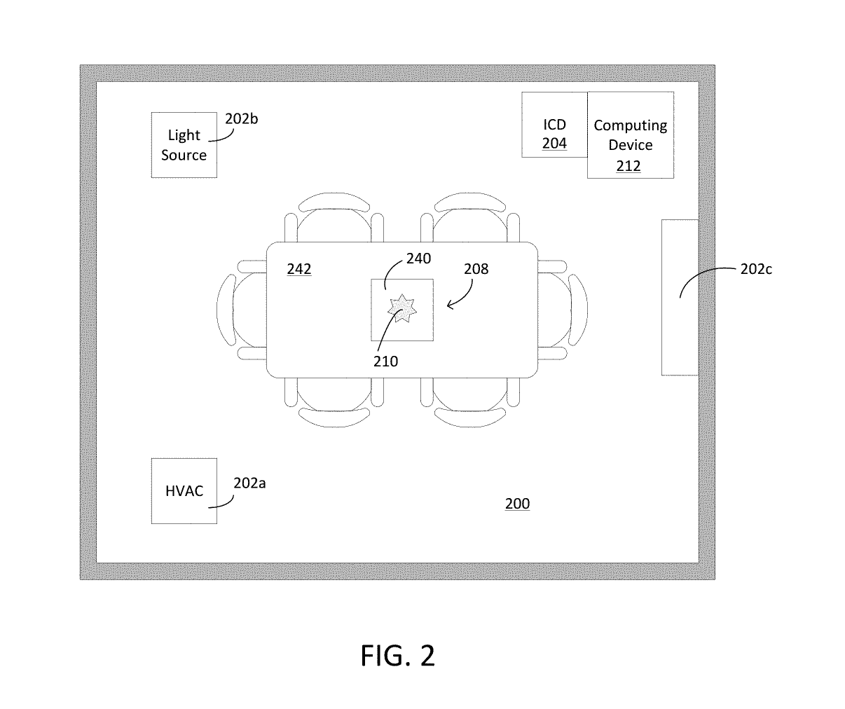

FIG. 2 illustrates a space 200 with building system components 202a-c controllable by a UI 208 and computing device 212. In the illustrated example, building system components 202 include HVAC system 202a, light source 202b, and window shades 202c. Each of building system components 202 are controllable by computing device 212. UI 208 includes a substrate 240, such as a piece of paper, that has a symbol 210 printed thereon. In use, space 200 may include a collection of substrates 240 and associated symbols 210, with each symbol corresponding to a control function of one or more building system components 202. A symbol 210 may correspond to just one control function, such as turning light source 202b on or off, or may correspond to a plurality of control functions, such as indicating a presentation mode associated with a plurality of control functions, in which, for example, light source 202b dims and window shades 202c are lowered. A user can make symbol 210 visible to image capture device (ICD) 204, for example, by placing UI 208 symbol-side up on a desk 242, for image capture by image capture device 204 and processing by computing device 212.

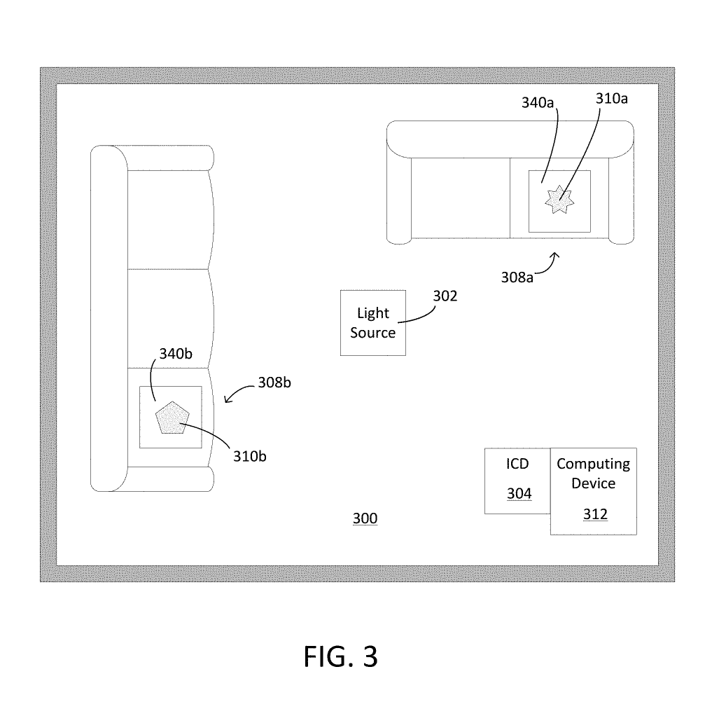

FIG. 3 illustrates a space 300 with a spatially-controllable light system that includes a building system component in the form of light source 302. Space 300 may have a plurality of light sources 302 located throughout the space 300 (although only one light source is illustrated) and/or light source(s) 302 may be configured to alter one or more of beam direction, beam angle, beam distribution, and/or beam diameter to vary lighting across the space. Space 300 may also include one or more image capture devices 304 that captures images of the space and a computing device 312 operatively coupled to the image capture device for analyzing captured images. FIG. 3 also shows two UIs 308a and 308b each in the form of a substrate 340a, 340b with a two-dimensional symbol 310a, 310b printed thereon. As shown UIs 308a and 308b are displaying different symbols 310a, 310b associated with different control functions for light source 302. Image capture device 304 and computing device 312 can be configured to capture one or more images that include both UI 308a and 308b. Computing device can execute symbol recognition application 128 (FIG. 1) to detect each of symbols 310a and 310b and also determine a spatial location of the UIs in space 300. Computing device can then communicate control signals to light source 302 that include location information to provide different lighting conditions in the areas or proximate the areas in which UIs 308a and 308b are located. For example, symbol 310a may be associated with a first mode, such as reading, and light source 302 can provide an optimal lighting intensity and temperature for the first mode in the area of UI 308a and symbol 310b may be associated with a second mode, such as a TV mode, and light source 302 can provide an optimal lighting intensity and temperature for the second mode in the area of UI 308b. In other examples, a symbol may contain directional information, such as an arrow and indicate a corresponding control function of light source 302 or some other building system component be performed in the vicinity or direction indicated by the arrow. For example a symbol with an arrow may be associated with a predefined lighting setting for one half of space 300 and the direction of the arrow may indicate the half of the space where the lighting settings should be applied.

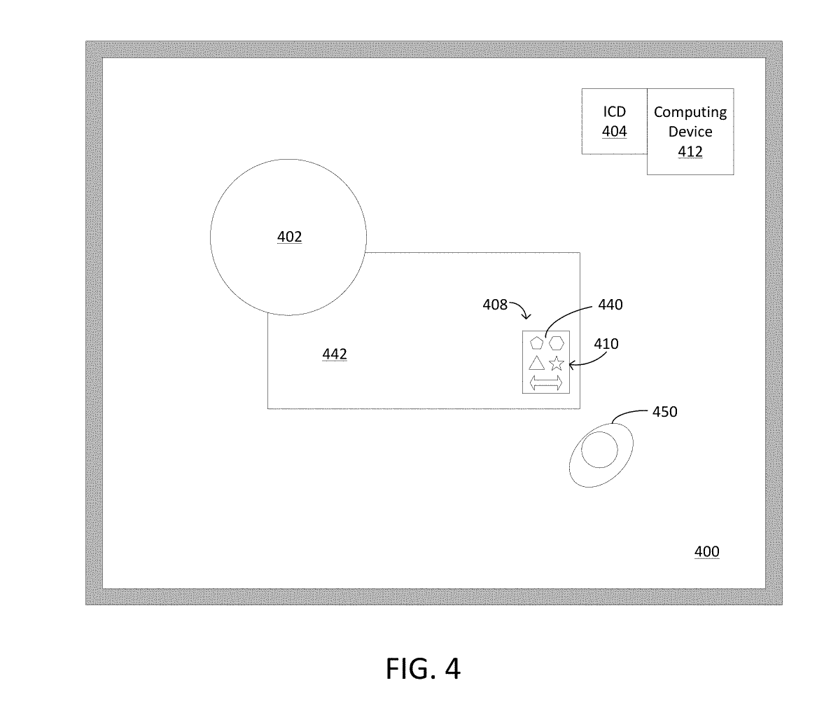

FIG. 4 illustrates an operating room 400 of a medical facility, which can include a building system component in the form of surgical overhead lighting 402 controllable by computing device 412. As is known in the art, operating rooms are sterile environments, and all objects in the room typically must be sterile, either by sterilizing the objects between each use or disposing of disposable objects after each use. In the illustrated example, surgical overhead lighting 402 can be controlled by a medical professional 450, such as a surgeon, via UI 408, which is illustrated in FIG. 4 as being located on a surface of an operating table 442. In one example, UI 408 includes a disposable substrate 440 in the form of, e.g., surgical cloth.

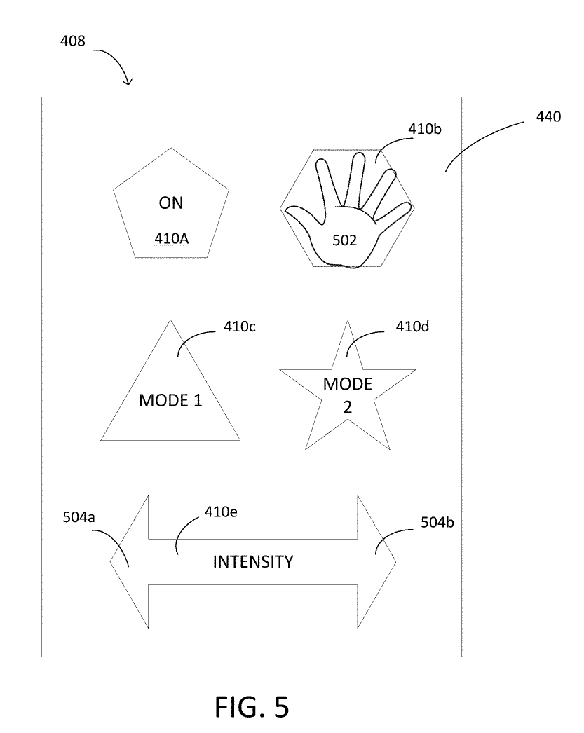

Symbols 410 are examples of gesture symbols. Unlike the examples illustrated in FIGS. 2 and 3, UI 408 includes a plurality of symbols 410 that are simultaneously displayed in the field of view of image capture device 404. User 450 may select a symbol 410 by gesturing to one of the symbols. For example, FIG. 5 shows a close-up view of UI 408 having symbols 410a-e. Each of symbols 410a-e can correspond to a different lighting control function, such as on 410a; off 410b; mode 1 410c; mode 2 410d; and light intensity 410e. As will be appreciated, symbols 410a-e and associated control functions are provided by way of example, and any number of symbols can be included and associated with any number of control functions. FIG. 5 also conceptually shows a hand 502 of user 405 (FIG. 4) placed over symbol 410b. In one example, image capture device 404 can continuously capture images of UI 408 and computing device 412 can analyze the images to determine when user 405 gestures over one of symbols 410, thereby selecting a particular symbol 410 and associated control function for surgical overhead lighting 402. Example symbol 410e is an example of a gradient symbol and is in the form of a double arrow for indicating increasing or decreasing light intensity. User 405 may gesture over one of the two arrows 504a, 504b and computing device 412 may be configured to increase or decrease the intensity of lighting 402 by a predetermined rate until the user removes his or her hand from the symbol. As will be appreciated, a similar gradient-based control scheme may be used for any control function of any building system component that is controllable over a range of values, such as beam direction, color temperature, etc.

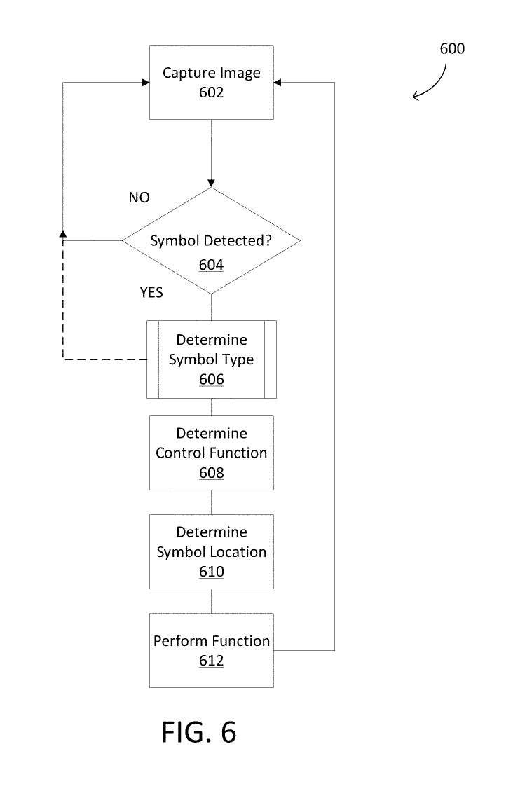

FIG. 6 illustrates one example process 600 for capturing an image of a symbol displayed on a UI (e.g., UI 108) with an image capture device (e.g., image capture device 104) and then processing the image with a computing device (e.g., computing device 112) to determine a control signal for controlling a function of a building system component (e.g., building system component 102). In block 602, the image capture device captures an image and at block 604, the computing device determines whether a pre-defined symbol is present in the image. For example, the computing device can apply one or more computer vision algorithms and techniques as described herein to determine if a pre-defined symbol is present in the image. For example, the computing device can determine if there are one or more characteristics associated with a pre-defined symbol present in the image.

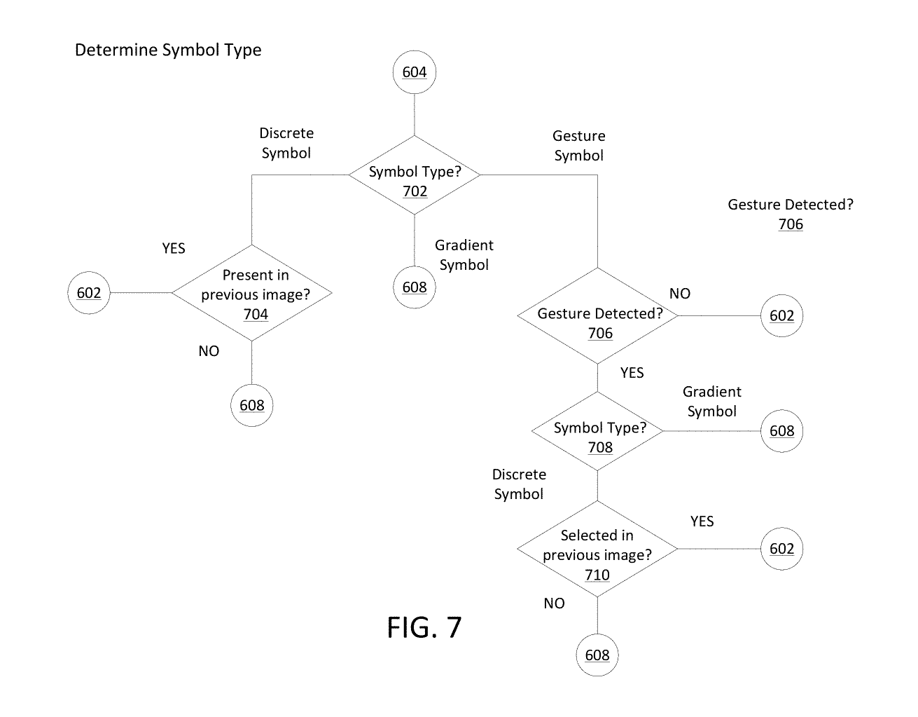

If, at block 604, a symbol is not detected, the process returns to block 602. If a symbol is detected, then at block 606 a sub-process for determining symbol type can be performed for determining if a control signal should be sent to a building system component. An example of the sub process at block 606 is illustrated in FIG. 7 and described below. If the computing device determines that no control signal should be transmitted after determining the symbol type, the process may return to block 602. At block 608, if the computing device determines the detected symbol indicates a control signal should be sent, the computing device can determine one or more building system component control functions associated with the detected symbol. At block 610, the computing device can also determine a location in space in which the symbol is detected, which may be used in some applications to include a spatial component to a building system component control signal (e.g., adjust lighting or climate control in a specific area within a larger space). At block 612, the computing device can send a control signal to one or more building system components for performing a function according to the detected symbol.

FIG. 7 illustrates one example of sub-process 606 of FIG. 6 for determining symbol type. At block 702, the computing device can determine what type of symbol has been detected. Three examples of symbol types are a discrete, gradient, and gesture symbols. In one example, a discrete symbol is associated with a single or discrete control function, such as ON, OFF, Mode, etc. In one example, a gradient symbol is associated with an incremental change in a control function controlled over a gradient, sometimes referred to herein as a gradient control function, such as an increase in brightness by a pre-defined amount, e.g., 5% increase or decrease in brightness. In one example, a gesture symbol indicates a control function when a user gestures to the symbol, such as symbols 410a-e (FIGS. 4 and 5). If at block 702, the computing device determines the detected symbol is a discrete symbol, at block 704, the computing device determines if the symbol was present in a previous image, such as the last image captured prior to the image being analyzed. If it was present, no action is required because the discrete action, such as turning a light on or off or turning on a mode, such as a reading mode, would have already occurred in the previous iteration and the user most likely left the symbol in view of the image capture device rather than putting it away. Thus, the process can return to block 602 to capture the next image. In another example, the computing device may also confirm the control signal from the discrete symbol captured in the previous image was actually performed to confirm the desired operation has occurred. If, at block 704, the computing device determines the symbol was not present in the previous image, then the process can proceed to block 608 (FIG. 6) to determine the control function and perform the function. In some examples, a discrete symbol may include a target environmental value that a building system component can control, such as a target luminance or color temperate of lighting within a space, which can be influenced by both lighting systems and window blinds controlled by computing device 112 as well as natural light sources and lighting sources not controlled by the computing device. In such examples, a feedback loop may be employed (not illustrated) where a sensor, such as image capture device 104, is used to measure the current environmental value in the space, such as luminance or color temperature, and computing device 112 can determine if a new control signal should be sent to building system component 102 to adjust the current environmental value to more closely match the target value associated with a discrete symbol. For example, a discrete symbol may be associated with an optimum lighting level for an office during working hours and as the day progresses from morning to afternoon to evening, computing device 112 can continually adjust an output of building system component 102 to maintain a constant light level within a space as a level of natural light increases and decreases throughout the day.

If at block 702 the computing device determines the detected symbol is a gradient symbol, then in one example, the process can continue to block 608 (FIG. 6) to determine the control function and perform the function. For example, a single symbol may be associated with increasing or decreasing a parameter by a predefined amount, e.g., 5% or 25%. In one example, in each iteration of process 600, or for each pre-defined number of iterations, e.g., 20, the computing device can continue to cause the building system component to perform a function. Thus, a user may present a symbol for increasing or decreasing a parameter, such as the intensity of a light, and the system may continuously increase or decrease the parameter until the user removes the symbol from the field of view of the image capture device, for example, by turning a piece of paper with the symbol over.

If at block 702 the computing device determines the detected symbol is a gesture symbol, then at block 706, the computing device determines if a user gesture selecting one of the symbols is detected. If not, then no action is required and the process returns to block 602. If a user gesture selecting a symbol has been detected, then at block 708, similar to block 702, the computing device can determine which symbol type was selected, for example, whether a discrete or gradient symbol was selected.

If at block 708 the computing device determines a user has gestured over a gradient symbol, then in one example, the process can continue to block 608 (FIG. 6) to determine the control function and perform the function. For example, a single symbol may be associated with increasing or decreasing a parameter by a predefined amount, e.g., 5% or 25%. One example of a gesture-gradient symbol is symbol 410e (FIG. 5), where a user can gesture over one of the two arrow heads to cause an intensity of light to increase or decrease. In one example, in each iteration of process 600, or for each pre-defined number of iterations, e.g., 20, the computing device can continue to cause the building system component to perform a function. Thus, a user may leave his or her hand over a gradient symbol, such as the intensity of a light, and the system may continuously increase or decrease the parameter until the user removes his or her hand from the symbol.

If at block 708 the computing device determines a user has gestured over a discrete symbol, then at block 710, the computing device determines if the user gestured over the symbol in a previous image, such as the last image captured prior to the image being analyzed. If yes, then no action is required because the discrete action, such as turning a light on or off or turning on a mode, such as a reading mode, would have already occurred in the previous iteration and the user did not moved his or her hand away from the symbol prior to capture of a subsequent image. Thus, the process can return to block 602 to capture the next image. In another example, the computing device may also confirm the command signal selected by the user in the previous image was actually performed to confirm the desired operation has occurred. If, at block 710, the computing device determines the user did not gesture to that symbol in the previous image, then the process can proceed to block 608 (FIG. 6) to determine the control function and perform the function.

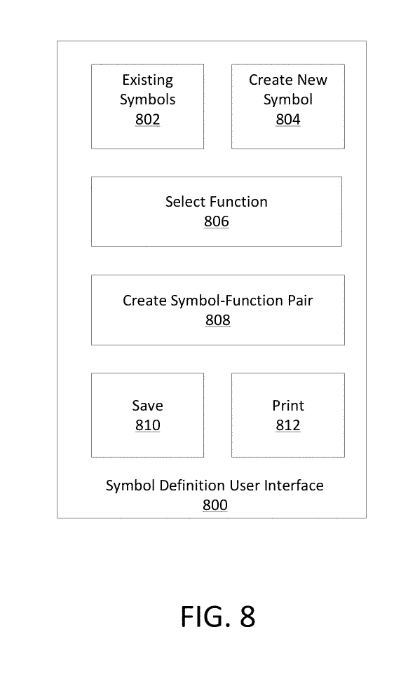

FIG. 8 illustrates one example of a symbol definition user interface (UI) 800 that may be used to define symbols (such as symbol 110) and associate building system component control functions with the symbols. In the illustrated example, symbol definition UI can be implemented on a computing device and may include an “Existing symbol” button 802 and a “Create new symbol” button 804, which can be used to select an existing symbol or create a new symbol, respectively. Symbol definition UI 800 can also include a select function button 806 for selection of a building system component function to associate with a symbol. Example symbol definition UI 800 may also include a create symbol-function pair button 808 for defining a new symbol-function pair, which can be saved in memory (e.g., symbol database 130) for use by a computing device (e.g., computing device 112) by selecting save button 810. The user can then print one or more symbols by selecting print button 812 to print the symbols on one or more substrates for creating a UI (e.g., UI 108) for controlling a building system component (e.g., building system component 102). In another example, if a display screen is used for displaying symbols, rather than printing selected symbols out on a substrate, the selected symbols can be made available in a software application for later selection by a user for controlling a building system component. Thus, a user may use UI 800 to customize the symbols and the control functions associated with a symbol as needed.

Any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

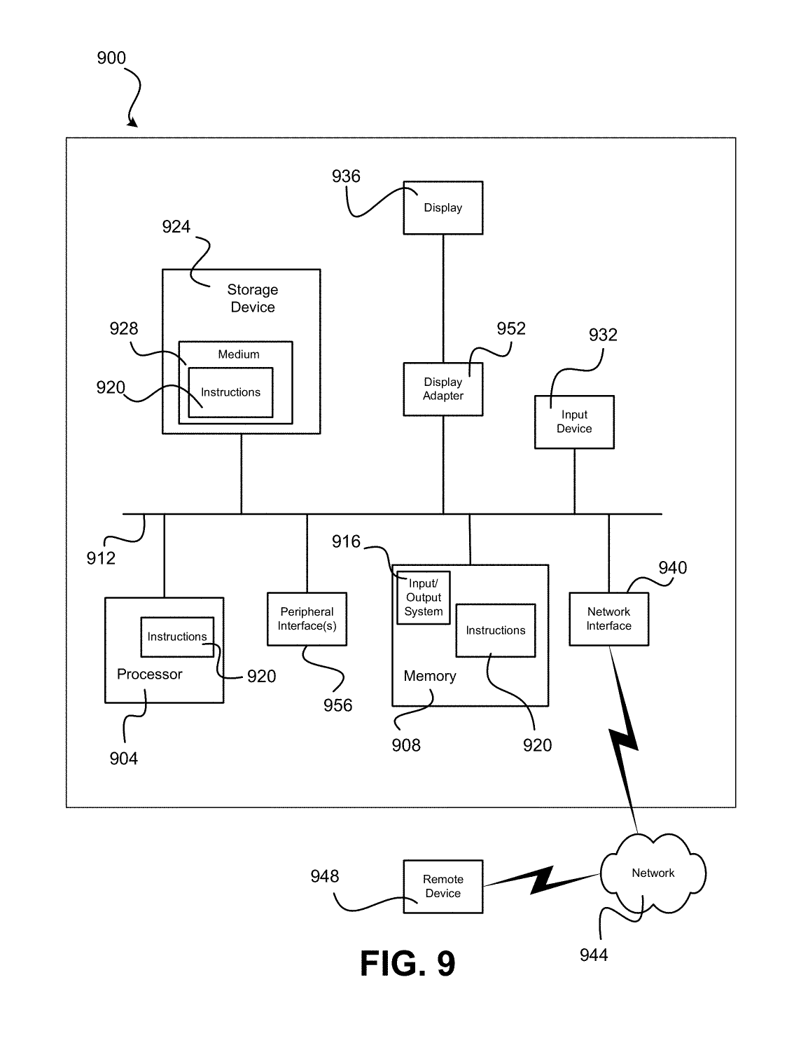

FIG. 9 shows a diagrammatic representation of one embodiment of a computing device in the exemplary form of a computer system 900 within which a set of instructions for causing a control system, such as system 100 of FIG. 1, to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 900 includes a processor 904 and a memory 908 that communicate with each other, and with other components, via a bus 912. Bus 912 may include any of several types of bus structures including, but not limited to, a memory bus, a memory controller, a peripheral bus, a local bus, and any combinations thereof, using any of a variety of bus architectures.

Memory 908 may include various components (e.g., machine-readable media) including, but not limited to, a random access memory component, a read only component, and any combinations thereof. In one example, a basic input/output system 916 (BIOS), including basic routines that help to transfer information between elements within computer system 900, such as during start-up, may be stored in memory 908. Memory 908 may also include (e.g., stored on one or more machine-readable media) instructions (e.g., software) 920 embodying any one or more of the aspects and/or methodologies of the present disclosure. In another example, memory 908 may further include any number of programs including, but not limited to, an operating system, one or more application programs, other programs, program data, and any combinations thereof.

Computer system 900 may also include a storage device 924. Examples of a storage device (e.g., storage device 924) include, but are not limited to, a hard disk drive, a magnetic disk drive, an optical disc drive in combination with an optical medium, a solid-state memory device, and any combinations thereof. Storage device 924 may be connected to bus 912 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 924 (or one or more components thereof) may be removably interfaced with computer system 900 (e.g., via an external port connector (not shown)). Particularly, storage device 924 and an associated machine-readable medium 928 may provide nonvolatile and/or volatile storage of machine-readable instructions, data structures, program modules, and/or other data for computer system 900. In one example, instructions 920 may reside, completely or partially, within machine-readable medium 928. In another example, instructions 920 may reside, completely or partially, within processor 904.

Computer system 900 may also include an input device 932. In one example, a user of computer system 900 may enter commands and/or other information into computer system 900 via input device 932. Examples of an input device 932 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 932 may be interfaced to bus 912 via any of a variety of interfaces (not shown) including, but not limited to, a serial interface, a parallel interface, a game port, a USB interface, a FIREWIRE interface, a direct interface to bus 912, and any combinations thereof. Input device 932 may include a touch screen interface that may be a part of or separate from display 936, discussed further below. Input device 932 may be utilized as a user selection device for selecting one or more graphical representations in a graphical interface as described above.

A user may also input commands and/or other information to computer system 900 via storage device 924 (e.g., a removable disk drive, a flash drive, etc.) and/or network interface device 940. A network interface device, such as network interface device 940, may be utilized for connecting computer system 900 to one or more of a variety of networks, such as network 944, and one or more remote devices 948 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 944, may employ a wired and/or a wireless mode of communication. In general, any network topology may be used. Information (e.g., data, instructions 920, etc.) may be communicated to and/or from computer system 900 via network interface device 940.

Computer system 900 may further include a video display adapter 952 for communicating a displayable image to a display device, such as display device 936. Examples of a display device include, but are not limited to, a liquid crystal display (LCD), a cathode ray tube (CRT), a plasma display, a light emitting diode (LED) display, and any combinations thereof. Display adapter 952 and display device 936 may be utilized in combination with processor 904 to provide graphical representations of aspects of the present disclosure. In addition to a display device, computer system 900 may include one or more other peripheral output devices including, but not limited to, an audio speaker, a printer, and any combinations thereof. Such peripheral output devices may be connected to bus 912 via a peripheral interface 956. Examples of a peripheral interface include, but are not limited to, a serial port, a USB connection, a FIREWIRE connection, a parallel connection, and any combinations thereof.

The foregoing has been a detailed description of illustrative embodiments of the disclosure. It is noted that in the present specification and claims appended hereto, conjunctive language such as is used in the phrases “at least one of X, Y and Z” and “one or more of X, Y, and Z,” unless specifically stated or indicated otherwise, shall be taken to mean that each item in the conjunctive list can be present in any number exclusive of every other item in the list or in any number in combination with any or all other item(s) in the conjunctive list, each of which may also be present in any number. Applying this general rule, the conjunctive phrases in the foregoing examples in which the conjunctive list consists of X, Y, and Z shall each encompass: one or more of X; one or more of Y; one or more of Z; one or more of X and one or more of Y; one or more of Y and one or more of Z; one or more of X and one or more of Z; and one or more of X, one or more of Y and one or more of Z.

Various modifications and additions can be made without departing from the spirit and scope of this disclosure. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present disclosure. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of this disclosure.

Exemplary embodiments have been disclosed above and illustrated in the accompanying drawings. It will be understood by those skilled in the art that various changes, omissions and additions may be made to that which is specifically disclosed herein without departing from the spirit and scope of the present disclosure.

1. A method of controlling a building system component, comprising:
analyzing, by a processor in a computing device, an image;
detecting, by the processor, a symbol in the image;
determining, by the processor, a control function associated with the symbol for controlling a building system component using a symbol database that associates a plurality of symbols with a plurality of control functions; and
transmitting a control signal to the building system component to cause the building system component to perform the control function.

2. The method of claim 1, wherein the image is of a space, and the building system component is configured to perform a function in the space.

3. The method of claim 2, wherein the symbol is displayed on a user interface located in the space.

4. The method of claim 2, wherein the space is an operating room and the building system component is overhead surgical lighting.

5. The method of claim 2, further comprising:
determining, by the processor, a location of the symbol within the space, wherein the control signal includes location information for performing the control function proximate to the location.

6. The method of claim 1, wherein the symbol is at least one of a machine-readable pattern printed on a substrate, a machine-readable pattern displayed on a display, or a temporal pattern emitted by a light emitting element.

7. The method of claim 1, further comprising:
detecting, by the processor, a user gesture over the symbol; and
determining, by the processor, the control function associated with the user gesture.

8. The method of claim 1, further comprising:
determining, by the processor, whether the symbol is associated with a discrete control function or a gradient control function.

9. The method of claim 8, further comprising:
analyzing, by the processor, a time-subsequent image in response to determining that that the symbol is associated with a gradient control function;
determining, by the processor, whether the symbol is in the time-subsequent image; and
continuing to transmit the control signal to the building system component in response to determining that the symbol is in the time-subsequent image.

10. A system, comprising:
an image capture device configured to capture images of a space;
a symbol database that associates a plurality of symbols with a plurality of control functions; and
a processor coupled to the image capture device and configured to:
analyze an image captured by the image capture device;
detect a symbol in the image;
determine a control function associated with the symbol for controlling a building system component using the symbol database; and
transmit a control signal to the building system component to cause the building system component to perform the control function.

11. The system of claim 10, wherein the image is of a space and the building system component is configured to perform a function in the space.

12. The system of claim 11, wherein the symbol is displayed on a user interface located in the space.

13. The system of claim 11, wherein the space is an operating room and the building system component is overhead surgical lighting.

14. The system of claim 11, wherein the processor is further configured to determine a location of the symbol within the space, wherein the control signal includes location information for performing the control function proximate the location.

15. The system of claim 10, wherein the symbol is at least one of a machine-readable pattern printed on a substrate, a machine-readable pattern displayed on a display, or a temporal pattern emitted by a light emitting element.

16. The system of claim 10, wherein the processor is further configured to:
detect a user gesture over the symbol; and
determine the control function associated with the user gesture.

17. The system of claim 10, wherein the processor is further configured to determine whether the symbol is associated with a discrete control function or a gradient control function.

18. The system of claim 17, wherein the processor is further configured to:
analyze a time-subsequent image in response to determining that that the symbol is associated with a gradient control function;
determine whether the symbol is in the time-subsequent image; and
continue to transmit the control signal to the building system component in response to determining that the symbol is in the time-subsequent image.
